(19) United States
(12) Patent Application Publication
(10) Pub. No.: US 2009/0006347 A1
(43) Pub. Date: Jan. 1, 2009

(54) Method and apparatus for conditional search operators

(75) Inventor: David S. Trollope, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/823,990

(22) Filed: Jun. 29, 2007

(51) Int. Cl. G06F 17/30

(52) U.S. Cl. 707/4; 707/E17.017

(57) ABSTRACT

Systems and methods for refining search results in response to a user query are disclosed. A search term can comprise a queried data sets coupled with a fundamental operator (e.g., AND, OR, NOT, etc.), and one or more conditional operators that filter at least one of the data sets prior to execution of the fundamental operator in order to reduce the size of the result set. Post-processing conditional operators can be applied after execution of the fundamental operator to further filter the result set. According to one aspect, conditional operators comprise a mathematical operator and a numerical value.

### BACKGROUND OF THE INVENTION

By way of background, information retrieval systems facilitate searching for information within a database or databases, which may reside in a single computer, in a local network of computers, or may be dispersed throughout the world-wide web. The sought information may be a document or information within a document, and may be searched by querying a search engine or the like, which evaluates query terms and finds matches in the database(s). Fundamental operators (e.g., AND, OR, NOT, etc.) are employed to generate a result set containing documents that match the queried terms, and the result set is then typically organized into a list based on some measure of relevance.

Search engines are increasingly taxed, and even out-paced, by web growth, such that users are often confronted with ever-increasing search durations and larger result sets. Users typically must pore over copious results in order to locate anything useful. Moreover, users are often not adept at selecting meaningful or precise search terms that yield desired results, which further exacerbates the issue.

Another disadvantage of conventional search algorithms relates to false positive results, which can occur when whole web pages are searched for key terms or phrases. For instance, a searched term or phrase may be present on a web page, causing it to be returned in the result set, but may not be relevant to the user's query. Such outlier results are undesirable and impede user efficiency.

There is an unmet need in the art for systems and methods that resolve the above-referenced deficiencies and others.

### SUMMARY OF THE INVENTION

A method and apparatus for refining search results using conditional operators to pre-filter and/or post-filter a result set are provided.

In one aspect of the invention, a system that facilitates refining search results for a user query comprises: a search engine that receives a query having at least one conditional operator and at least one fundamental operator; and a processor that applies the at least one conditional operator to filter a first data set, and applies the fundamental operator to operate on the filtered first data set and at least a second data set.

According to another aspect, a method of refining search results for a user query comprises: receiving a query with at least one conditional operator and at least one fundamental operator; filtering a first data set using the conditional operator; and generating a refined data set by executing the fundamental operator on the filtered first data set and at least a second data set.

According to another aspect, a method of refining search results responsive to a user query comprises; receiving a query comprising at least one fundamental operator, a post-processing indicator, and at least one post-processing conditional operator; executing the fundamental operator on at least two data sets to generate a result set; and executing the conditional operator on the result set to filter items in the result set.

An advantage of the various aspects described herein is that finding a “needle in the haystack” result is facilitated such that a user who is looking for one or a few specific results in a large data set is able to locate such result(s) without the system having to process the large data set.

Another advantage resides in eliminating outlier results for a searched data set to provide a user with common results.

Another advantage resides in improving user productivity by eliminating outlier results and facilitating location of the specific result(s).

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The subject innovation exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 provides an illustration of a system for refining search results in response to a user query in order to reduce a result set that is presented to the user and to facilitate finding a “needle in the haystack” result;

FIG. 2 illustrates a system in which the search engine is employed in an Internet environment;

FIG. 3 is an illustration of a method of employing conditional search operators to refine a search result set, in accordance with various aspects described herein; and

FIG. 4 is an illustration of a method of employing a post-processing indicator in conjunction with conditional operators to generate a refined result set in response to a search query, in accordance with one or more aspects.

### DETAILED DESCRIPTION

This invention relates to a method and apparatus for providing conditional search operators and specifying search terms in a search engine or mechanism with increased precision.

While the invention is particularly directed to the art of search engines, and will be thus described with specific reference thereto, it will be appreciated that the invention may have usefulness in other fields and applications. For example, the invention may be used in communication devices, computing devices, or any other devices in which it is desirable to refine filtering of search results, etc.

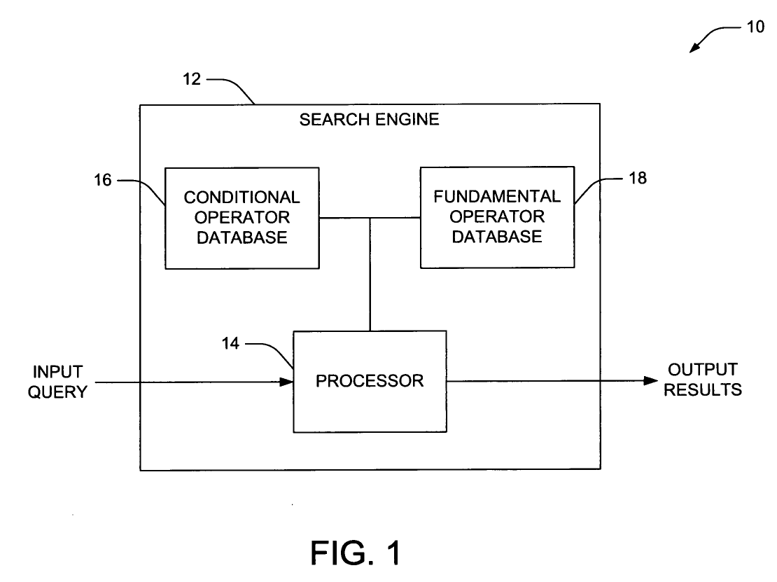

Referring now to the drawings wherein the showings are for purposes of illustrating the exemplary embodiments only and not for purposes of limiting the claimed subject matter, FIG. 1 provides an illustration of a system 10 for refining search results in response to a user query in order to reduce a result set that is presented to the user and to facilitate finding a “needle in the haystack” result. As shown generally, the system 10 comprises a search engine 12 that comprises various components for executing a search algorithm to refine conventional search results. The search engine 12 comprises a processor 14 that executes computer-executable instructions for employing one or more conditional operators in conjunction with fundamental operators, entered by a user, to refine search results. Accordingly, a conditional operator database 16 and a fundamental operator database 18 are operatively coupled to the processor 14, and respectively store conditional operators and fundamental operators, as well as instructions for executing a search of queried terms using such operators.

According to one or more aspects, the system 10 permits a user to more precisely include or exclude sets of data from a result set based on the quantity of results. For instance, a user can elect to filter results so that only a large or small number of results are returned, as a function of the conditional operators included in the query. This, in turn, allows the user to quickly find a single or very few results without waiting for the entire result set to be processed. Moreover, the user can exclude outlier results when desired.

According to an example, the conditional operators can be employed in addition to fundamental logical operators (e.g., AND, OR, NOT, etc.) to further refine a result set as a function of the quantity of results. The conditional operators can be mathematical operators. According to an example, the mathematical operators include < (less than), > (greater than), and = (equal to). Such operators can be coupled together to generate a greater-than-or-equal-to operator (e.g., >= or =>), or a ≧ symbol can be used to achieve such. Similarly, operators can be coupled together to generate a less-than-or-equal-to operator (e.g., <= or =<), or a ≦ symbol can be used to achieve such. In another example, modulus values can be used as mathematical operators to refine search results.

Each side of a fundamental operator can be specified by pre-fixing or post-fixing a condition and a number. For instance, a fundamental operator such as “AND” can be conditioned to #<AND>#, where <and> are mathematical conditions and # represents a number. According to an example, a traditional search for “A AND B” can be refined as a conditional operator search for “A 5<AND>3 B.” In this example, in result set A, any items with collective counts less than 5 will be returned and ANDed with items having a collective count of greater than 3 from result set B (e.g., only items that have a collective count of less than 5 in A and a collective count of more than 3 in B). Thus, the conditional operators are applied prior to the fundamental operator in order to reduce the final result set to a set of results specifically sought by the user.

According to another example, the traditional search “A OR B” can be refined to “A 2<OR B,” which will result in a final result set that includes all results from set B and results with a collective count less than 2 from set A. In yet another example, “A NOT B” can be refined to “A NOT>3 B” to yield a refined result set including all results from set A and excluding results from set B that have a collective count greater than 3. Thus, the numerical terms and associated conditions can be employed to count a number of items on each side of a fundamental operator and filter them prior to applying the fundamental operator to the result set.

According to another example, the following results sets may represent animals on farms A and B, although the underlying concepts can be applied to any suitable data set, as will be appreciated by those of skill. Farm A: {cat dog sheep cow}. Farm B: {cat cat cat dog turkey}. The triplication of “cat” in Farm B's data set is deliberate in this example, and illustrates that Farm B has three cats. A traditional search employing only fundamental operators, “A AND B,” would yield {cat dog sheep cow cat cat cat dog turkey}. However, applying conditional operators on one or both sides of the fundamental operator can refine the results. For instance, if the search were conditioned as “A AND>2 B,” the refined result set would be {cat dog sheep cow cat cat cat} since there are more than two cats in set B. Additionally, items in set B that have collective counts of 2 or less (e.g., dog and turkey in this example), are excluded from the refined result set by the conditional operator “>2.” Additionally, such items can be excluded from the data set before the fundamental operator is executed, thereby reducing search time. In this manner, outlier data can be removed from a data set as part of the initial search. Moreover, prefixing and post-fixing the search term permits each data set to be individually manipulated.

To further this example, the conditional operator can be inverted to facilitate finding a “needle-in-the-haystack” result. For instance, if the traditional search were refined to “A AND<2 B, the refined result set would be {cat dog sheep cow dog turkey}.

Other aspects of the system 10 facilitate implementing conditions on a result set after processing of the fundamental operator rather than operating on each individual data set. A post-processing indicator can be employed to distinguish between conditions to be implemented prior to application of the fundamental operator and conditions to be applied after the implementation of the fundamental operator. According to an example, a search employing a post-processing indicator can have the following notation:

# CONDITION OPERATOR CONDITION #: CONDITION #

where “#” indicates a numerical value, “CONDITION” indicates, for instance, a mathematical operator (e.g., >, <, =, ≧, ≦, etc.), and “OPERATOR” indicates a fundamental operator (e.g., AND, OR, NOT, etc.). In the above example the post-processing indicator is represented by a colon (:), although it will be appreciated that other representations thereof are possible.

An example of a search using a post-processing indicator, using the above notation and in conjunction with the previous example regarding farms A and B might be “A 1=AND>2:>3 B,” in which case the refined result set would be {cat cat cat cat}. For instance, the conditional operators preceding the colon are executed first, and the conditional operator following the colon is then applied to the result set from the preceding conditional operators. That is, data set A is refined to exclude any data items that do not have a collective count equal to 1. In this particular example, all items in data set A have a collective count of 1, and thus the resulting data set contains all items in data set A. Data set B is refined to exclude items with collective counts of 2 or less (e.g., dog and turkey), which leaves only {cat cat cat}. Refined data sets A and B are then ANDed together to yield {cat dog sheep cow cat cat cat}, and the pre-processing conditional operations are complete. At this point, the post-processing conditional operator (e.g., >3) is applied, which excludes items in the initially refined set whose collective counts are 3 or less (e.g., dog, sheep, and cow), leaving the final refines result set {cat cat cat cat}.

Other examples include multiple conditional operators and multiple fundamental operators in larger searches, which facilitate powerful yet simple searching. For instance, “X AND>2 Y 100<OR Z,” etc.

It will be appreciated that the foregoing examples are illustrative in nature, and are not intended to limit the number or type of conditional or fundamental operators that can be employed in conjunction with the various systems and methods described herein. For instance, any suitable fundamental operator may be employed in the described systems and methods, including but not limited to AND, OR, NOT, NOR, XOR, XNOR, NAND, tautological operators, contradictory operators, if-then operators, etc.

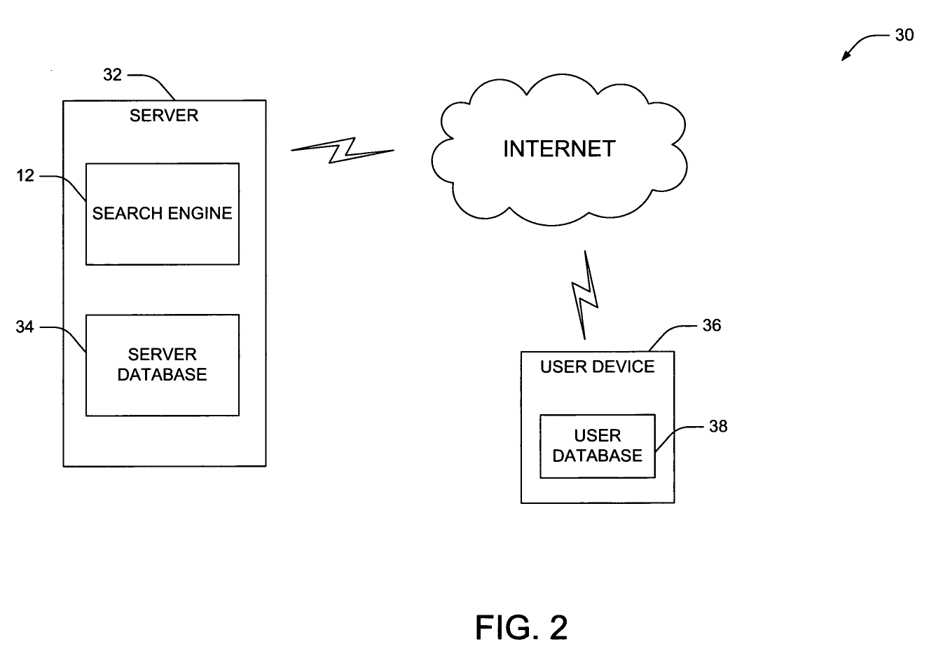

FIG. 2 illustrates a system 30 in which the search engine 12 is employed in an Internet environment. For instance, the system 30 (and/or the system 10 described above) can be implemented in a database on a user's hard drive, in local network database, or over the Internet when searching the world-wide-web or other networked document storage system. The system 30 comprises a server 32 in which the search engine 12 is employed, and the server 32 further comprises a server database that may be searched using the conditional operator systems and methods described herein, in addition to other databases. The server 32 can be coupled to a user device 36 over the Internet or another suitable channel or connection (e.g., wired or wireless). The user device in turn comprises a user database 38, which can buffer and/or store refined results sets and the like for presentation to the user via the user device 36.

The user device can be, for example, a personal computer, a laptop or tablet PC, a personal digital assistant (PDA), a cellular phone, or any other suitable communication or computing device capable of providing a user interface for a user. The user can enter search terms, such as are described in the above examples or the like, into the user device 36, and the search terms are processed by the search engine 12 to generate a refined result set for presentation to the user via the user device 36.

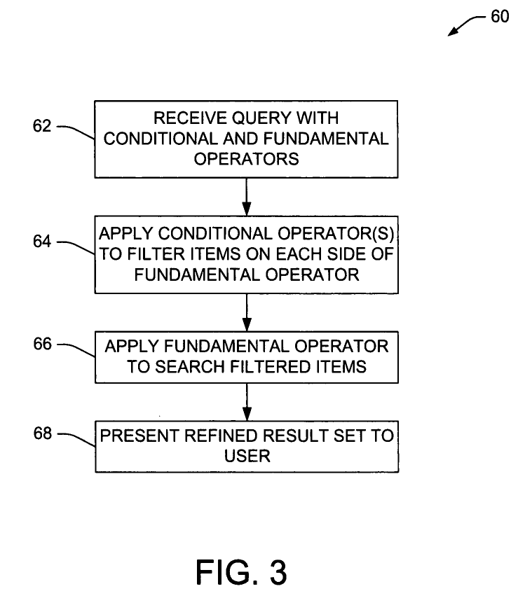

FIG. 3 is an illustration of a method 60 of employing conditional search operators to refine a search result set, in accordance with various aspects described herein. At 62, a query is received (e.g., at a search engine or the like) comprising conditional and fundamental operators. At 64, conditional operators are applied to filter items in data sets on one or both sides of a fundamental operator. At 66, the fundamental operator can be employed to perform a function on the filtered data sets. At 68, a refined data set is presented to a user. In this manner, data sets can be preconditioned for action by the fundamental operator, to more precisely identified results desired by the user.

According to an example, a user may desire to identify a song in a playlist to which the user has listened in recent months, but for which the user cannot remember any names. To further this example, the playlist comprises thousands of songs and cannot easily be reviewed by the user. Moreover, in this example, the user recalls first hearing in the playlist in June, and then listening to the song multiple times on the fourth of July. If data set X includes all songs in the playlist that the user listened to in June, and data set Y includes songs in the playlist that the user listened to in July, a traditional search of “X AND Y” will return all songs listened to the user both June and July. Such a result set may include hundreds or thousands of songs and is not very useful to the user. However, using conditional operators, the user may enter a query such as “X=1AND>5 Y,” which can be received at 62. The search engine can then filter songs in the June data set to exclude songs that were listened to more than once, and the July data set to exclude songs that were not listened to at least 6 times, at 64. At 66, the filtered June and July data sets can be ANDed to compile a refined result set, and the refined results can be presented to the user at 68. In this manner, the user can identify all songs that the user listened to several times in July but only once in June, which results in a refined result set that can be more easily reviewed by the user.

It is to be appreciated that the foregoing example is illustrative in nature and is not intended to limit the scope of the types of data sets that can be searched, the conditional and/or functional operators or number thereof that may be employed, etc., with the various systems and methods presented herein.

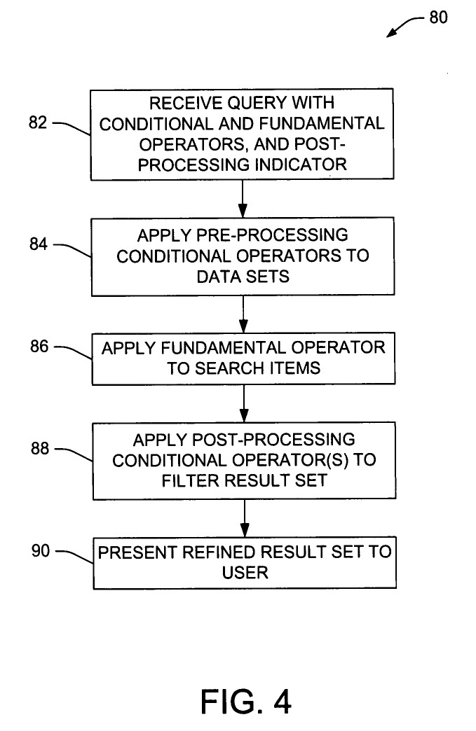

FIG. 4 is an illustration of a method 80 of employing a post-processing indicator in conjunction with conditional operators to generate a refined result set in response to a search query, in accordance with one or more aspects. At 82, a query with conditional and fundamental operators, as well as a post-processing indicator, is received. At 84, pre-processing conditional operators are applied to data sets on zero, one, or both sides of a fundamental operator to filter the data set(s) prior to operation thereon by the fundamental operator. At 86, the fundamental operator is applied to the data sets. At 88, a post-processing conditional operator is applied to the resulting data set to further refine the results. At 90, the refined data set is presented to the user.

Returning to the playlist example of FIG. 3, a user who wants to generate a new playlist comprising favorite songs from the June and July listening periods can enter, for instance, “X≧10AND>9:>29 Y” as a query. In this example, the query is received at 82 with components comprising a fundamental operator (AND), at least one conditional operator (≧10, >9, >29) and a post-processing indicator (:). The pre-processing conditional operators are applied to the June and July data sets to filter out songs that were played fewer than 10 times, at 84. At 86, the fundamental operator is applied to AND the filtered X and Y data sets together. The post-processing conditional operator is then applied to further refine the resultant ANDed data set to exclude all songs that were played 29 or fewer times during the months of June and July combined, at 88. At 90, the user is presented with a refined data set comprising a list of songs listened to at least 30 times over the two month period and at least 10 times in each respective month. In this manner, the user can exclude, for instance, a song that may have been listened to 29 times in June and only once in July, after the user had tired of the song.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system that facilitates refining search results for a user query, comprising:
a search engine that receives a query having at least one conditional operator and at least one fundamental operator; and
a processor that applies the at least one conditional operator to filter a first data set, and applies the fundamental operator to operate on the filtered first data set and at least a second data set.

2. The system of claim 1, further comprising a conditional operator database that stores machine-executable instructions for applying the at least one conditional operator to one or more data sets.

3. The system of claim 2, further comprising a fundamental operator database that stores machine-executable instructions for applying the at least one fundamental operator to one or more data sets.

4. The system of claim 1, wherein the processor applies the conditional operator to filter the first data set and before applying the fundamental operator to the first and second data sets to generate a refined data set.

5. The system of claim 1, wherein the query further comprises a post-processing indicator that is followed by a post-processing conditional operator.

6. The system of claim 5, wherein the processor applies the post-processing conditional operator to the refined data set to further filter data items therein.

7. The system of claim 1, wherein the conditional operator comprises a mathematical operator and a numerical value.

8. The system of claim 7, wherein the mathematical operator is at least one of >, <, =, ≦, or ≧.

9. A method of refining search results for a user query, comprising:
receiving a query with at least one conditional operator and at least one fundamental operator;
filtering a first data set using the conditional operator; and
generating a refined data set by executing the fundamental operator on the filtered first data set and at least a second data set.

10. The method of claim 9, further comprising presenting refined data set is presented to a user.

11. The method of claim 9, wherein the query comprises at least a second conditional operator.

12. The method of claim 11, further comprising employing the second conditional operator to filter the second data set.

13. The method of claim 9, further comprising filtering the first data set before executing the fundamental operator.

14. The method of claim 9, wherein the query further comprises a post-processing indicator followed by at least a third conditional operator.

15. The method of claim 14, further comprising filtering the refined data set by executing the third conditional operator after executing the fundamental operator.

16. The method of claim 9, wherein the conditional operator comprises a mathematical operator and a numerical value.

17. The method of claim 16, wherein the mathematical operator is at least one of >, <, =, ≦, or ≧.

18. A method of refining search results responsive to a user query, comprising:
receiving a query comprising at least one fundamental operator, a post-processing indicator, and at least one post-processing conditional operator;
executing the fundamental operator on at least two data sets to generate a result set; and
executing the conditional operator on the result set to filter items in the result set.

19. The method of claim 18, wherein the conditional operator comprises a mathematical operator and a numerical value.

20. The method of claim 19, wherein the mathematical operator is at least one of >, <, =, ≦, or ≧.
